(19) United States
(12) Patent Application Publication
(10) Pub. No.: US 2016/0019023 A1
(43) Pub. Date: Jan. 21, 2016

(54) LOW-POWER ACOUSTIC DATA ACQUISITION SYSTEM AND METHODS

(71) Applicant: Cornell University, Ithaca, NY (US)

(72) Inventors: Harold Cheyne, Trumansburg, NY (US); Adam Strickhart, Reston, VA (US); Peter Marchetto, Ithaca, NY (US); Raymond Mack, Cortland, NY (US); Richard Gabrielson, Vestal, NY (US); Robert Koch, Ithaca, NY (US); Amanda Kempf, Ithaca, NY (US)

(21) Appl. No.: 14/775,842

(22) PCT Filed: Mar. 13, 2014
(86) PCT No.: PCT/US14/25691

§ 371 Date: Sep. 14, 2015

Related U.S. Application Data
(60) Provisional application No. 61/789,840, filed on Mar. 15, 2013.

(51) Int. Cl. G06F 3/16; G05B 15/02

(52) U.S. Cl. CPC G06F 3/165; G05B 15/02

(57) ABSTRACT

A system and methods for monitoring, acquiring, and recording acoustic data configurable for low-power operation. Embodiments of the system configured for low-power operation, advantageously may be deployed in remote environments for extended periods of time. Embodiments of the system may include an audio processor configured for low power operation and may include a microcontroller operably coupled to audio processor and a storage device. Additional embodiments may include a housing configure to withstand harsh environments for extended periods of time.

This application claims the benefit of U.S. Provisional Application No. 61/789,840, filed on Mar. 15, 2013, which is incorporated by reference in its entirety.

### TECHNICAL FIELD

This following invention is directed to systems and methods for storing acoustic data and, more particularly, to low-power acoustic data acquisition.

### BACKGROUND

Remote acoustic recording devices may be used to record acoustic data. Remote acoustic recording devices include an audio transducer and a recordable medium. Remote acoustic recording devices may be deployed in an air-borne or an underwater acoustic environment. Remote acoustic recording devices are typically deployed in environments where access to power from utilities is not readily available and are typically powered by portable power supplies. It is desirable for remote acoustic recording devices to be deployed for extended periods of time (e.g., days, weeks, or months).

The length of time a remote acoustic recording device may be deployed may be based on the recording capacity of a recordable medium, capacity of a portable power supply, and/or the operational efficiency of a remote acoustic recording device (i.e., power required to record an amount of data). Further, the durability of a remote acoustic recording acoustic device (i.e., ability to withstand exposure to harsh environments) may limit the length of time a remote acoustic recording device may be deployed. Current commercially available acoustic recording devices may be less than ideal for extended deployment in environments where acoustic monitoring is desired.

A demand therefore exists for a system and methods for acoustic monitoring and recording that can be deployed for extended periods of time. The present invention satisfies the demand.

### SUMMARY

The present invention is directed to a system and methods for monitoring, acquiring, and storing acoustic information. Certain embodiments are directed to low-power acoustic data acquisition systems. Certain additional embodiments are directed to a low-power acoustic data acquisition system and methods that are configured to be deployed for extended periods of time.

According to one embodiment of the invention, a system for recording acoustic data includes an audio processor, a microcontroller, a storage device, and a power supply, wherein one or more of these components are configured for low-power operation.

According to another embodiment of the invention, the system for recording audio data includes one or more processors, a storage device, a power supply, wherein the one or more processors and the storage device may be configured to continuously record acoustic data for up to 40 days using power supplied by the power supply, and an enclosure housing the one or more processors, the storage device, and the power supply.

The details of one or more embodiments of the invention are shown in the accompanying drawings and the description below. Other features, objects, and advantages will be apparent from the description and drawings, and from the claims.

### BRIEF DESCRIPTION OF DRAWINGS

FIG. 1 is a block diagram illustrating one embodiment of a remote acoustic recording device according to the present invention.

FIG. 2 is a block diagram illustrating another embodiment of a remote acoustic recording device according to the present invention.

FIG. 3 is a block diagram illustrating an additional embodiment of a remote acoustic recording device according to the present invention.

FIG. 4 is an image illustrating an example of a circuit board of an embodiment according to the present invention.

FIG. 5 is an image illustrating an embodiment of a remote acoustic recording device according to the present invention.

FIG. 6 is a view of the embodiment of the remote acoustic recording device illustrated in FIG. 5 with the cover removed.

FIG. 7 is an exploded view of the embodiment of the remote acoustic recording device illustrated in FIG. 5 according to the present invention.

### DETAILED DESCRIPTION

The length of time a remote acoustic recording device may be deployed may be based on the recording capacity of a recordable medium, energy capacity of a portable power supply, and/or the operational efficiency of an extended remote acoustic recording device (i.e., power required to record an amount of data). The present invention is directed to a system and methods for monitoring, acquiring, and storing acoustic data that may require much less electrical power than current commercially available recorders and therefore may be more versatile and have greater utility. The system may be used for unattended, archival, long-term acoustic recording devices. A system according to the present invention may typically be used in environments where traditional sources of power are not readily available. A system according to the present may be energy efficient and therefore may allow them to function on battery power for extended periods of time. In one embodiment of the present invention is a low-power acoustic data acquisition system based on an analog-to-digital converter (ADC), a microcontroller (μC), and micro Secure Digital (micro SD) memory card storage configuration.

A system according to the present invention may be used, for example, to monitor wildlife activity (both in the air and in the water, such as vocalizations from birds, elephants, whales, and fish) and for ambient acoustic monitoring, such as for noise measurements related to human activity (e.g., pre- and post-construction of an airport). Embodiments of the present invention may be used in harsh environments (e.g., desert environments, arctic environments, high-wind environments, and/or underwater environments). Additional embodiments may be submersible and may include components that are rated for the industrial temperate range of −40 to +85 degrees Celsius.

Products designed for archival acoustic recording are known, for example, the SongMeter2+ available from Wildlife Acoustics of Concord, Mass. and the DSG available from Loggerhead Instruments of Sarasota, Fla. However, known devices may require significantly more energy for similar recording durations than embodiments according to the present invention. Embodiments according to the present invention may use half the energy consumption of known devices, may weigh half as much as such products, and/or may use more efficient memory types than such products.

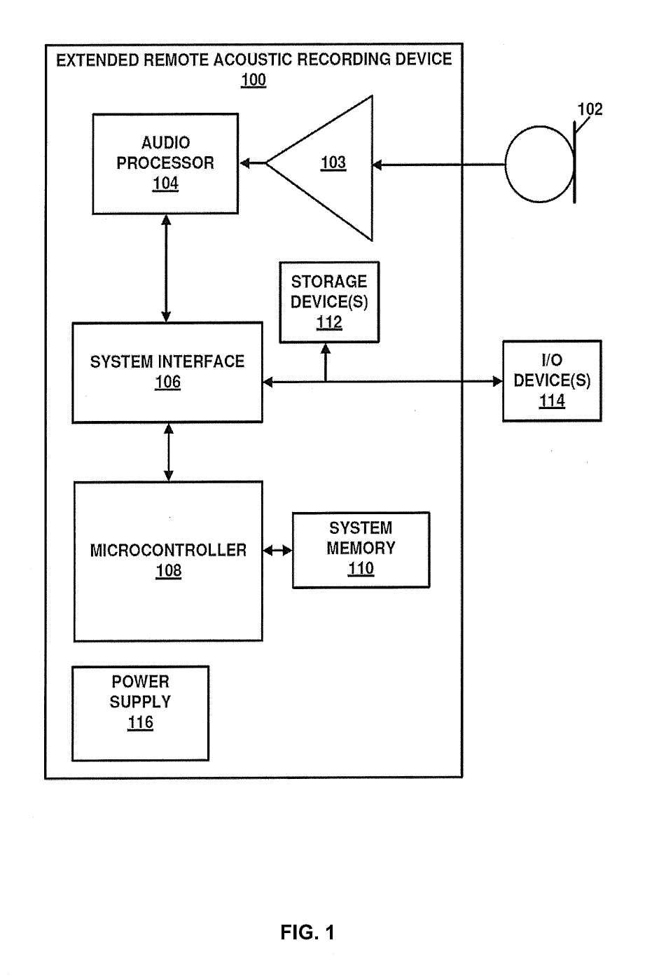

FIG. 1 is a block diagram illustrating an embodiment of a remote acoustic recording device embodiment according to the present invention. Remote acoustic recording device 100 may be configured to monitor, acquire, and record acoustic information such as during an extended deployment. Remote acoustic recording device 100 may include or be part of another device. In some examples, remote acoustic recording device 100 may be included in a device having radio frequency communication capabilities. For example, remote acoustic recording device 100 may be operable coupled to a wireless transmitter in communication with a base station (e.g., for communication of command and control information). Remote acoustic recording device 100 may be configured for low-power operation, which may enable extended deployment.

Remote acoustic recording device 100 includes acoustic transducer 102, analog stage 103, audio processor 104, system interface 106, microcontroller 108, system memory 110, storage device(s) 112, I/O device(s) 114, and power supply 116. It should be noted that although example remote acoustic recording device 100 is illustrated as having distinct functional blocks, such an illustration is for descriptive purposes and does not limit remote acoustic recording device 100 to a particular hardware architecture. Functions of remote acoustic recording device 100 may be realized using any combination of hardware, firmware, and/or software implementations.

Acoustic transducer 102 may be configured to convert sound waves to an electrical signal. Acoustic transducer 102 may be an internal acoustic transducer or an external acoustic transducer. Acoustic transducer 102 may be configured to operate in an air-borne acoustic environment or an underwater acoustic environment. Acoustic transducer 102 may operate according to one or more of electromagnetic induction, capacitance change, and/or piezoelectric generation. Acoustic transducer 102 may be an external acoustic transducer and may be operably coupled to extended remote acoustic recording device 100 using a standard wired connection. In one example, acoustic transducer 102 may be a microphone configured for a particular type of acoustic monitoring. For example, acoustic transducer 102 may include an omnidirectional microphone configured to monitor wildlife within a desired region. In one example, acoustic transducer 102 may include a hydrophone configured for underwater acoustic data collection. In one example, audio transducer 102 may include an ultrasonic microphone configured to record high frequency acoustic data.

Analog stage 103 may be configured to receive an electrical signal from an acoustic transducer, such as, for example, acoustic transducer 102 and condition an electrical signal for an audio processor, such as, for example, audio processor 104. In one example, analog stage 103 may include an amplifier and/or an analog audio filter. For example analog stage 103 may be configured to amplify an electrical signal and perform, DC, high, and/or low pass filtering on the electrical signal. In the example where analog stage 103 includes a filter, a filter may be a passive or an active filter.

Audio processor 104 may be configured to receive electrical signals and generate audio data. In one example, audio processor 104 may be configured to generate digital audio data from electrical signals. For example, audio processor 104 may be configured to generate pulse-code modulation (PCM) digital audio data from received electrical signals. Audio processor 104 may include an analog to digital converter. Further, in one example, audio processor 104 may include a digital signal processor. An analog to digital converter may be configured to convert an electric signal into a digital audio signal. A digital signal processor may process a digital audio signal. For example, a digital signal processor may be configured to apply digital filters to a digital audio signal. In one example, audio processor 104 may be programmable. For example, sample rate and bit depth may be configurable.

It should be noted that in some examples remote acoustic recording device 100 may be configured for multi-channel recording and may include multiple acoustic transducers and audio processor 104 may be configured to receive electrical signals corresponding to one or more channels and generate multi-channel audio data. In one example, audio processor 104 may be configured to operate in a low-power and/or low voltage mode. For example, audio processor 104 may be configured to operate within a supply voltage range of 1.1 to 3.6 V.

System interface 106 may be configured to enable communication between components of remote acoustic recording device 100. In one example, system interface 106 comprises structures that enable data to be transferred from one peer device to another peer device or to a storage medium. For example, system interface 106 may include circuitry, wires, and/or corresponding logic supporting one or more bus protocols, such as, for example, Advanced Microcontroller Bus Architecture (AMBA) bus protocols, Peripheral Component Interconnect (PCI) bus protocols, Serial Peripheral Interface (SPI) bus, or any other form of structure that may be used to interconnect peer devices. In one example, system interface 106 may be configured to support an Integrated Interchip Sound (also known as I²S, Inter-IC Sound, Integrated Interchip Sound, and IIS) standard, such that PCM digital audio data may be communicated between one or more components of remote acoustic recording device 100 and audio processor 104.

Microcontroller 108 may be configured to implement functionality and/or process instructions for execution in remote acoustic recording device 100. Microcontroller 108 may be capable of retrieving and processing instructions, code, configuration information, and/or data structures for implementing one or more of the techniques described herein. Instructions may be stored on a computer readable medium, such as system memory 110 or storage devices 112. In one example, microcontroller 108 may read configuration information from system memory 110 and provide configuration information to audio processor 104. For example, microcontroller 108 may provide audio processor 104 with a sampling rate and/or a bit depth. Microcontroller 108 may include digital signal processors (DSPs), general purpose microprocessors, application specific integrated circuits (ASICs), field programmable logic arrays (FPGAs), or other equivalent integrated or discrete logic circuitry. In one example, microcontroller 108 may be configured to operate in a low-power and/or low voltage mode. For example, microcontroller 108 may be configured to operate within a voltage supply range of 2.2 to 3.6 V.

System memory 110 may be configured to store information that may be used by remote acoustic recording device 100 during operation. System memory 110 may be used to store program instructions for execution by microcontroller 108 and may be used by microcontroller 108 to temporarily store audio data. For example, system memory 110 may store configuration information. Further, microcontroller 108 may use system memory 110 as a buffer for audio data.

System memory 110 may be described as a non-transitory or tangible computer-readable storage medium. In some examples, system memory 110 may provide temporary memory and/or long-term storage. In some examples, system memory 110 or portions thereof may be described as non-volatile memory and in other examples portions of system memory 110 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. In one example, system memory 110 may include non-volatile memory storing instructions for execution by microcontroller. Further, system memory 110 may include volatile memory for temporarily storing digital audio data from audio processor 104. Digital audio data may be buffered in system memory 110 prior to being stored on storage devices 112.

Storage device(s) 112 represent memory of extended remote acoustic recording device 100 that may be configured to store relatively larger amounts of information for relatively longer periods of time than system memory 110. Similar to system memory 104, storage device(s) 112 may also include one or more non-transitory or tangible computer-readable storage media. Storage device(s) 112 may be internal or external memory devices and in some examples may include volatile and/or non-volatile storage elements. Storage medium may include flash memory, or any other suitable digital storage media. In one example, storage device(s) 112 may include Secure Digital (SD) memory devices. Standards related to SD memory device are maintained by the SD Association are incorporated by reference herein. SD memory devices may include SD, SDHX, SDXC, iniSD, microSD, miniSDHC, microSDHC, microSDXC, smartSD, smartSDHC, SDIO, and miniSDIO memory devices.

I/O device(s) 114 may include external devices configured to receive data from and output data to remote acoustic recording device 100. In some examples, I/O device(s) 114 may be operatively coupled to remote acoustic recording device 100 using a standardized communication protocol, such as for example, Universal Serial Bus protocol (USB). In one example, I/O device(s) 114 may be used to program microcontroller 108. In one example, I/O devices(s) 114 may be configured to retrieve audio data from remote acoustic recording device 100.

Power supply 116 may be configured to provide power to remote acoustic recording device 100. In one example, power supply 116 may include one or more batteries configured to power remote acoustic recording device 100 for up to 40 days of continuous recording. In one example, power supply may include three D-cell alkaline batteries. Other battery types and configurations may be used (e.g., sealed lead acid, lithium ion, NiCad, and NiMH batteries).

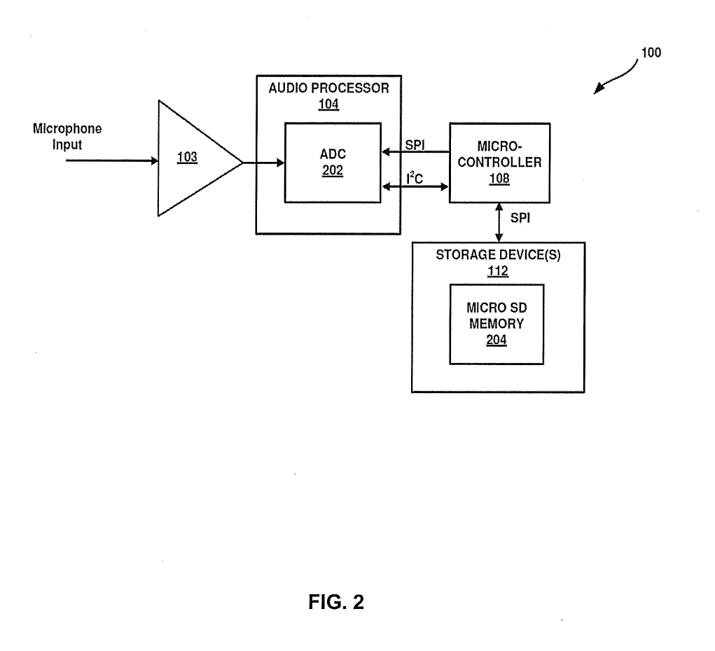

As described above, remote acoustic recording device 100 may be configured for low-power operation, which may enable extended deployment. FIG. 2 provides a block diagram illustrating an embodiment according to the present invention. FIG. 2 illustrates an embodiment of the components of an embodiment of the remote acoustic recording device 100 in further detail. In the embodiment illustrated in FIG. 2, audio processor 102 and microcontroller 108 may be configured for low-power operation. In one embodiment, audio processor 102 and microcontroller 108 may respectively include an audio processor and a microcontroller designed for use in a mobile phone. As described above, system interface 106 may be configured to enable communication between components of remote acoustic recording device 100. Each of SPI and I²C buses illustrated in FIG. 2 represent example components of system interface 106

In the embodiment illustrated in FIG. 2, audio processor 104 may include analog to digital converter 202 and may be configured to receive configuration information from microcontroller 108 via an SPI bus and communicate audio data to microcontroller 108 using I²C. In one example, audio processor 104 may be integrated circuit part number TI TLV320AIC3204 available from Texas Instruments or a similar part available from Texas Instruments or another manufacturer. In one example microcontroller 108 may be configured to operate within a supply voltage range of 1.1 to 3.6 V. In one example, audio processor 104 may be configured to operation within a temperature range of −40 to +85 degrees Celsius.

As further illustrated in the embodiment illustrated in FIG. 2, microcontroller 108 may be configured to communicate with storage device(s) 112 via an SPI bus and storage device(s) include micro SD memory 204. Micro SD memory may be a micro SD memory card or may be a flash memory configured to store data according to the micro SD standard. Micro SD may include 8 pins for communication defined according to the micro SD standard. Storage device(s) 112 may include an interface for converting SPI signals to 8-pin signals for use with a micro SD memory. It should be noted that micro SD memories typically requires less power than standard SD memories.

As describe above, microcontroller 108 may be configured for low-power operation. In one embodiment, microcontroller 108 may be integrated circuit part number TI MSP430F5438A available from Texas Instruments, or a similar embodiment available from Texas Instruments or another manufacturer. In one embodiment, microcontroller 108 may be configured to operate within a supply voltage range of 2.2 to 3.6 V. In one embodiment, microcontroller 108 may be configured to operation within a temperature range of −40 to +85 degrees Celsius. In one embodiment, microcontroller 108 may operate as follows: read configuration information from a memory, such as for example, system memory 110 and/or storage devices 114, initialize an audio processor, such as, for example, audio processor 104 using configuration information, receive digitized acoustic data from an audio processor in a buffer memory, such as, for example, system memory 110 and/or storage devices 114, and write a block of data to an SD memory, such as for example, micro SD memory 204.

In another embodiment, microcontroller 108 may be configured to write blocks of data to an SD memory while continuing to receive digitized acoustic data. Further, microcontroller 108 may be configured to continue to receive digitized acoustic data from audio processor 104 in a buffer memory and write a block of data to an SD memory until one or more of the following occurs: a SD memory is full, power is removed, or configuration information indicates a recording stop.

In addition to being configured to communicate using techniques that require relatively low-power, microcontroller 108 further be configured to enable low-power operation of remote acoustic recording device 100 by being configured to collect the incoming acoustic data and only store the data to micro SD memory 204 periodically; that is, microcontroller 108 may be configured to write blocks of data to micro SD memory 204 based on a time interval or based on an amount of data in a buffer.

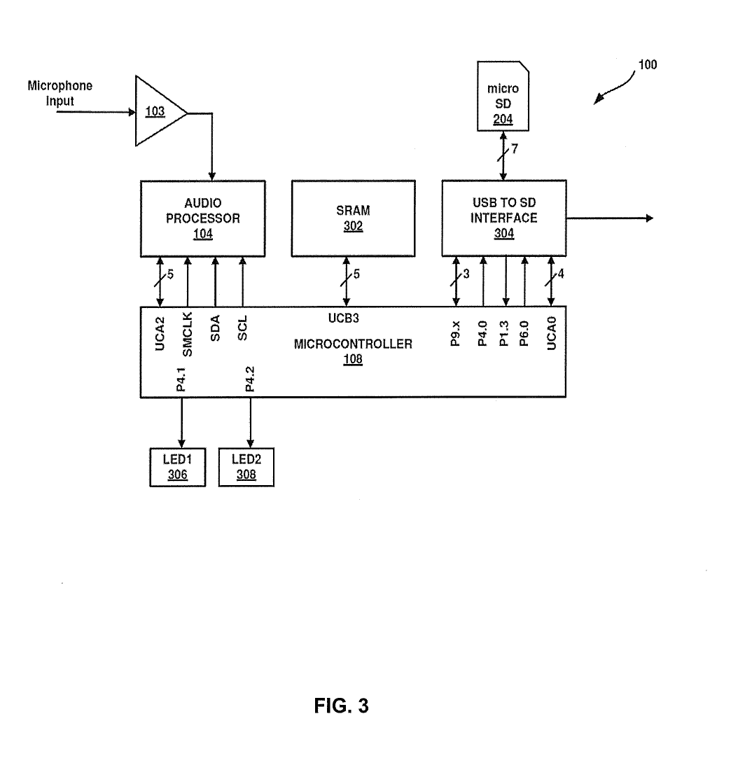

As described above, remote acoustic recording device 100 may be implemented using a plurality of integrated circuits. FIG. 3 is a block diagram illustrating a detailed example implementation of an embodiment remote acoustic recording device 100 that may implement one or more methods according to the present invention. In the embodiment illustrated in FIG. 3, IC pin connections are illustrated. In the embodiment illustrated in FIG. 3, audio processor 104 includes integrated circuit part number TI TLV320AIC3204 available from Texas Instruments, microcontroller 108 includes integrated circuit part number TI MSP430F5438A available from Texas Instruments, micro SD memory 204 includes a micro SD card. Further, in the embodiment illustrated in FIG. 3, SRAM 302, USB-to-SD interface 304, LED1 306, and LED2 308 are coupled to microcontroller 108 at indicated pins.

In one embodiment, SRAM 302 may include 256 kb of SRAM and may be implemented in a package available from Micron. SRAM 302 may be configured as a buffer for audio data. USB-to-SD interface 304 may be configured to receive data from microcontroller 108 and communicate data to/from a USB device and to/from a micro SD card. In one embodiment, USB-to-SD interface 304 may be integrated circuit part number MAX14502 available from Maxim available or a similar part available from Maxim or another manufacturer.

LED1 306 and LED2 may be light emitting diodes configured to provide an operating status of remote acoustic recording device 100. For example, LED1 may include a green LED indicating whether remote acoustic recording device 100 is powered on and LED2 may include a red LED indicating whether audio data is being written to micro SD 204. As indicated in FIG. 3, components may be coupled to microcontroller 108 at indicated IC pin connections. For the sake of brevity, details of IC pins connections are not described herein. However, reference is made to datasheets maintained by respective manufacturers describing details of IC pin connections each of which are incorporated by reference herein.

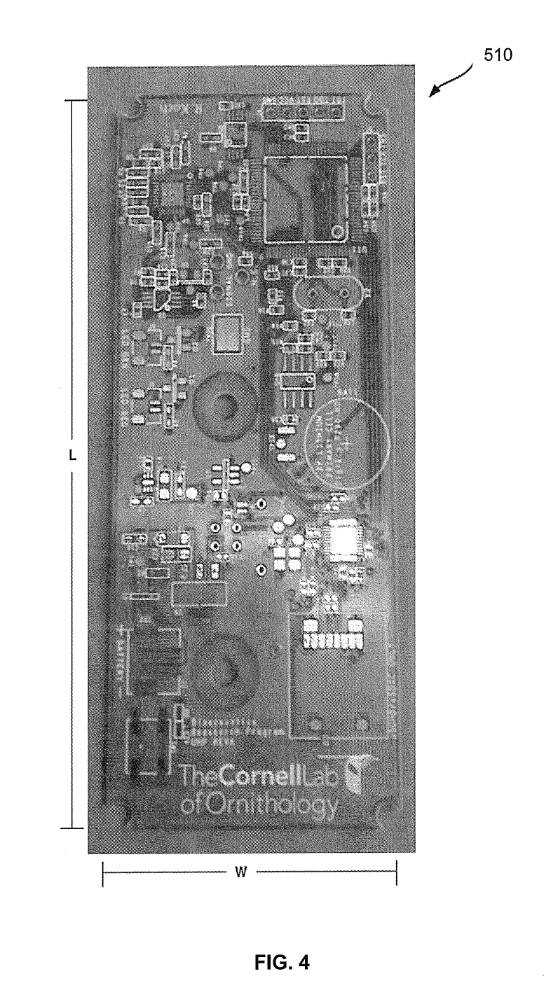

Each of the integrated circuits described with respect to FIG. 3 may be electrically connected to a circuit board. FIG. 4 is an image illustrating an embodiment of a circuit board that may be used to implement one or more methods according to the present invention. In one embodiment, circuit board 510 may be configured such that the example integrated circuits described above with respect to FIG. 3 may be operably coupled to circuit board. In one example, circuit board 510 may have a width, W, of approximately 1.625 inches and a length, L, of approximately 4 inches.

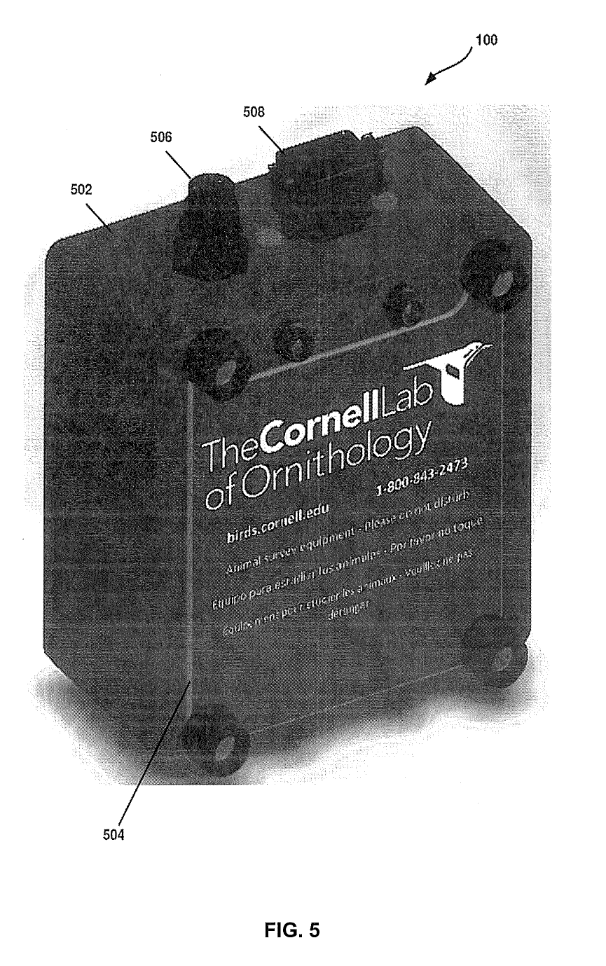

In one embodiment, in order to withstand harsh environments circuit board 510 may be housed within a protective enclosure housing. FIG. 5 provides an image illustrating an embodiment of a remote acoustic recording device 100 that may implement of the method according to the present invention. As illustrated in FIG. 5, remote acoustic recording device 100 may include cover 502, identification plate 504, microphone port 506, and I/O device port 508.

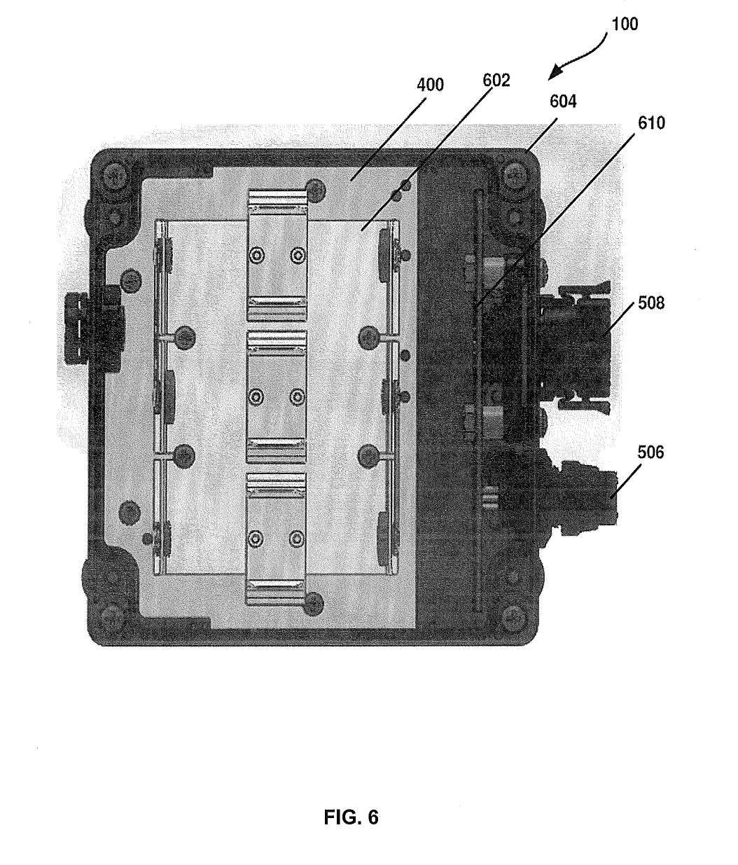

FIG. 6 provides a view of an embodiment of the remote acoustic recording device 100 illustrated in FIG. 5 with the cover 502 removed. As illustrated in FIG. 6, remote acoustic recording device 100 may include battery holder 602, back panel 604, and circuit board 510.

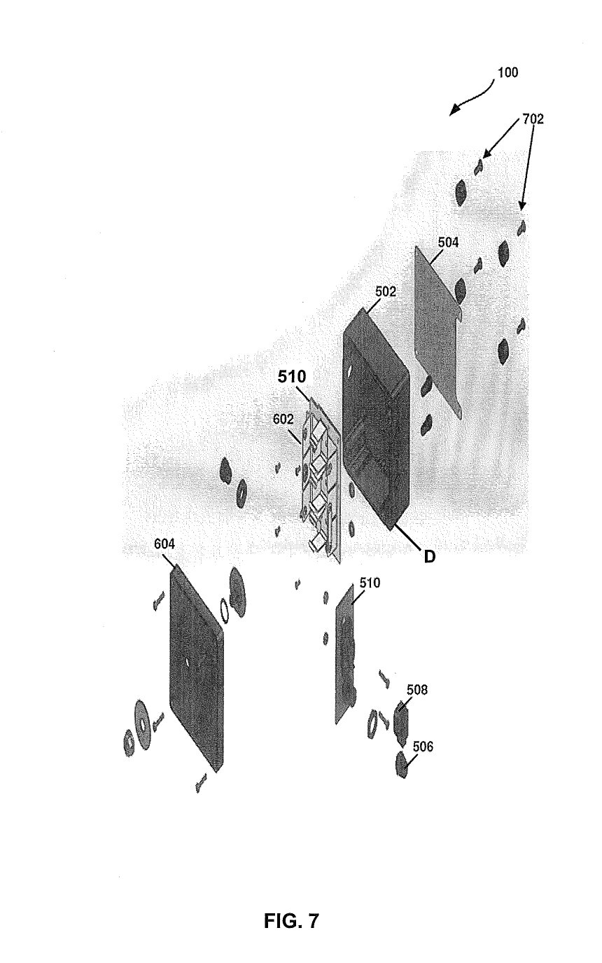

FIG. 7 provides an exploded view of the embodiment of the remote acoustic recording device 100 illustrated in FIG. 5. As illustrated in FIG. 7, remote acoustic recording device 100 may include fastening and spacing components 702.

As illustrated in FIGS. 5-7, cover 502 and back panel 604 may form an enclosure for circuit board 510 and battery holder 602. In the example illustrated in FIG. 7, cover 502 may include a recess for receiving circuit board 510 and battery holder 602. As described above, remote acoustic recording device 100 may be configured to operate using a power supply including three type-D batteries. Battery holder 602 may be configured to hold three type-D batteries. As illustrated in FIGS. 6 and 7, battery holder 602 may be operably coupled to circuit board 510 opposite a side where the electrical components, including the integrated circuits described above, are electronically coupled. Recess may include in cover 502 significant depth “D” in order to accommodate the diameter of a type D-battery, the height of circuit board 510, and the height of any electrical components extending from circuit board 510. In one embodiment, the depth of recess may be approximately 1.625 inches.

As illustrated FIG. 5, remote acoustic recording device 100 may include identification plate 504 affixed to cover 502. Identification plate 504 may include information identifying the owner of remote acoustic recording device 100. Further, identification plate 504 may include instructions intended for any one finding the remote acoustic recording device 100. As described above, remote acoustic recording device 100 may be used for monitoring wildlife for an extended period of time. As a result, in one example, identification plate 504 may provide information indicating where the remote acoustic recording device 100 was deployed for wildlife monitoring and may include instructions indicating that remote acoustic recording device 100 should not be disturbed.

As described above, an external acoustic transducer, such as for example, acoustic transducer 102 may be operable coupled to remote acoustic recording device 100. Microphone port 506 may be configured to accommodate an acoustic transducer connector. For example, microphone port 506 may be configured to accommodate a 2.5 mm mono connector, a 3.5 mm mono connector, a 3.5 mm stereo connector, a ¼ inch stereo connector, or an XLR connector. In one embodiment, microphone port 506 may be configured to protect an acoustic transducer connector and corresponding circuitry from harsh elements. For example, microphone port 506 may be configured to prevent debris and/or water from interacting with circuitry (e.g., to prevent electronic shorts). For example, microphone port 506 may include rubber and other types of sealants.

As described above, an external I/O device, such as, for example I/O device(s) 114 may be operable coupled to remote acoustic recording device 100. I/O device port 508 may be configured to accommodate an I/O device connector. For example, I/O device port 508 may be configured to accommodate a USB standard-A plug, a USB standard-B plug, a USB mini-B plug, a USB micro-B plug, or a proprietary I/O plug. In one embodiment, I/O device port 508 may be configured to protect an I/O device connector and corresponding circuitry from harsh elements. For example, I/O device port 508 may be configured to prevent debris and/or water from interacting with I/O circuitry. For example, I/O device port 508 may include rubber and other types of sealants.

In the embodiment illustrated in FIGS. 5-7, microphone port 506 and I/O device port may be secured using port connector panel 610 where port connector panel is enclosed within cover 502. It should be noted that although microphone port 506 and I/O device port 508 are illustrated as protruding from a single side of cover, in other embodiment, microphone port 506 and I/O port 508 may respectively be located on different sides of cover 502.

As illustrated in FIG. 7, circuit board 510, cover 502, identification plate 504, port connector panel 610, and back panel 604 may be coupled together using fastening and spacing components 702. For the sake of brevity, each of the individual fastening and spacing components 702 are not described in detail. As illustrated in FIG. 7 fastening and spacing components 702 may include bolts, washers, nuts, and spacers. Fastening and spacing components 702 may be configured to couple circuit board 510, cover 502, identification plate 504, port connector panel 610, and back panel 604 together in a secure manner and in a manner that prevents elements from breaching the enclosure. For example, fastening and spacing components 702 may be configured in a manner such that debris and/or water is prevented from coming in contact with circuit board 510. In one embodiment, bolts may be conditioned with an adhesive and/or a sealant. In one embodiment, fastening and spacing components 702 may enable remote acoustic recording device 100 to be submersible in up to 1 meter of water without water breaching the enclosure. In this manner, example remote acoustic recording devices described herein represent examples of low-power acoustic data acquisition systems configured to be deployed for extended periods of time.

In one or more embodiments, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The system and methods accorded to the present invention may be implemented in a wide variety of devices or apparatuses, including a wireless handset, an integrated circuit (IC) or a set of ICs (e.g., a chip set). Various components, modules, or units are described to emphasize functional aspects of devices configured to perform the describe methods, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiment have been described. These and other examples are within the scope of the following claims.

What is claimed is:

1. A device for recording acoustic data, device comprising:
an audio processor;
a microcontroller;
a storage device; and
a power supply, wherein said audio processor, said microcontroller, and said storage device are configured for low-power operation.

2. The device of claim 1, wherein said power supply includes three type-D batteries and wherein said audio processor and said microcontroller are configured to continuously record acoustic data using power supplied by power supply for an extended period of time.

3. The device of claim 1, wherein said audio processor is configured to operate using a supply voltage within a range of 1.1 to 3.6 V.

4. The device of claim 1, wherein said microcontroller is configured to operate using a supply voltage within a range of 2.2 to 3.6 V.

5. The device of claim 1, wherein said microcontroller is configured to provide configuration information to the audio processor using a Serial Peripheral Interface (SPI) bus.

6. The device of claim 5, wherein said audio processor is configured to provide audio data to the microprocessor using an Inter-Integrated Circuit bus.

7. The device of claim 6, wherein said storage device includes a micro SD card and the microcontroller is configured to write data to said micro SD card using a Serial Peripheral Interface (SPI) bus.

8. The device of claim 1, wherein said storage device includes a micro SD card, and wherein the device further comprises an interface configured to receive audio data from said microcontroller using a Serial Peripheral Interface (SPI) bus and transmit the received acoustic data to said micro SD card using micro SD card pins.

9. The device of claim 8, wherein said interface is further configured to output data to a Universal Serial Bus (USB) device.

10. The device of claim 9, wherein said microcontroller is configured to provide configuration information to audio processor using said a Serial Peripheral Interface (SPI) bus and wherein said audio processor is configured to provide the audio data to said microprocessor using an Inter-Integrated Circuit bus.

11. A device for recording audio data, the device comprising:
one or more processors;
a storage device;
a power supply, wherein said one or more processors and said storage device are configured to continuously record acoustic data for an extended period of time using power supplied by said power supply; and
an enclosure housing said one or more processors, said storage device, and said power supply.

12. The device of claim 11, wherein said power supply includes three type-D batteries.

13. The device of claim 12, wherein said enclosure includes a cover including a recess configured to receive a circuit broad electrically connecting said one or more processors and said power supply.

14. The device of claim 13, wherein a battery holder is operably coupled to a side of said circuit board.

15. The device of claim 14, wherein said one or more processors are operable couple to a side of said circuit board opposing a side of said battery holder.

16. The device of claim 15, wherein said one or more processors includes an audio processor is configured to operate using a supply voltage within a range of 1.1 to 3.6 V.

17. The device of claim 15, wherein said one or more processors includes a microcontroller is configured to operate using a supply voltage within a range of 2.2 to 3.6 V.

18. The device of claim 10, wherein said enclosure includes an identification plate operably coupled to said cover.

19. The device of claim 10, wherein said enclosure includes a microphone port.

20. The device of claim 16, wherein said enclosure include a Universal Serial Bus (USB) port.
